(19) United States
(12) Patent Application Publication
(10) Pub. No.: US 2014/0334905 A1
(43) Pub. Date: Nov. 13, 2014

(54) Mobile Transport Cart

(71) Applicant: Tronair Inc., Holland, OH (US)

(72) Inventors: Paul A. Spinazze, Toledo, OH (US); Wayne Grebe, Whitehouse, OH (US)

(73) Assignee: TRONAIR INC., Holland, OH (US)

(21) Appl. No.: 14/134,146

(22) Filed: Dec. 19, 2013

Related U.S. Application Data
(60) Provisional application No. 61/821,927, filed on May 10, 2013.

(51) Int. Cl. B60P 3/055; B60P 1/00

(52) U.S. Cl. CPC B60P 3/055; B60P 1/00
USPC 414/482; 280/400

(57) ABSTRACT

This mobile, cylinder transport cart is based on a four cylinder transport cart, designed to minimize the handling of nitrogen and oxygen cylinders in the loading, transporting and servicing process and to provide boosted compressed gas for an aircraft, oxygen to fill crew and passenger oxygen bottles. The cylinders are locked into place by a cylinder locking clamp. The rotational loader is locked into place by a spring loaded plunger that locks loader into in either horizontal or vertical position.

### CROSS REFERENCE TO RELATED APPLICATION

The present patent application is based upon and claims the benefit of provisional patent application No. 61/821,927, filed on May 10, 2013.

### FIELD OF THE INVENTION

The present invention relates to the field of aviation but not limited to and, more particularly, to a mobile four cylinder transport cart and booster system.

### BACKGROUND OF THE INVENTION

Various aircraft maintenance equipment has been developed for maintaining various portions of an aircraft. Aircraft ground servicing, specifically, provides electrical, hydraulic fluid, and gaseous inputs to aircraft at or on remote locations. An aircraft on the ground whose engine is not functioning requires a number of services to determine whether the aircraft is in a condition to fly or taxi. These services include: electrical power, hydraulic power, engine-start capability (bleed-air), air conditioning or heating of the aircraft's interior, oxygen to fill crew and passenger oxygen bottles, and nitrogen to inflate struts and operate power tools.

The present invention is based on a four cylinder transport cart, designed to minimize the handling of nitrogen and oxygen cylinders in the loading and unloading, transporting and servicing process and to provide boosted compressed gas for an aircraft.

### SUMMARY OF THE INVENTION

The present invention provides an apparatus that includes a booster system provides hi and low pressure regulated pressure output. The transport cart allows a single operator to load full nitrogen or oxygen cylinders, transport them to and from the aircraft to service the aircraft, without ever having to lift the cylinders. Once the booster system has fully depleted the cylinders of nitrogen or oxygen the cart can be unloaded without ever lifting the cylinder onto or off of the cart. The unique quality of this cart is the operator never has to lift a cylinder onto the cart. The cylinders can weight between 120 and 175 lbs. The cart has a very narrow footprint and a tight turning radius allowing the cart to maneuver easily.

The process to load and unload the cart is described herein. The cart is located adjacent to the cylinders and the towbar actuating brake is engaged. The cylinders are staged next to the cart for loading. The cylinder loader locking pin is released and the cylinder loader is moved into the vertical loading position so the cylinders can be rolled onto the rotating 2 cylinder loader deck. Once each cylinder is loaded onto the loader deck it is secured in position by the cylinder lock down clamp. The correct loading sequence is to load the forward cylinder (the cylinder closest to the tray or towbar) then load the second cylinder.

Once both cylinders are loaded and locked down the cylinder loader locking pin is disengaged in the vertical position and then the cylinders are then rotated to the horizontal position and the loader locking pin is engaged in the horizontal position. This same process is completed on the other side of the cart for the additional 2 cylinders.

If only two or three cylinders are loaded into the cart an alternate loading procedure should take place. If only 2 cylinders are loaded one cylinder should be loaded in the forward position on each side to keep the cart balanced and ensure the lowest center of gravity. If only 3 cylinders are loaded then one side should be loaded with 2 cylinders and the second side should be loaded with one cylinder in the forward position.

Another feature of the carts is the forward tray that houses the oxygen and nitrogen systems including hoses, regulators, control panel and operating instructions.

The nitrogen and oxygen carts can be outfitted with additional systems to allow full usage of the oxygen and nitrogen in the cylinders. The additional systems include either a nitrogen booster or oxygen booster and all of the components that make up a booster system. The booster system allows the operator to fully deplete the cylinders of gas prior to exchanging.

Other objects and advantages of the present invention will become apparent to those skilled in the art upon a review of the following detailed description of the preferred embodiments and the accompanying drawings.

### IN THE DRAWINGS

FIG. 1 is a general view of the Mobile Transport Cart of this invention.

FIG. 2 is a general view showing a typical aircraft.

FIG. 3 is a general view showing a typical gas (nitrogen or oxygen) cylinder (bottle).

### DETAILED DESCRIPTION OF THE INVENTION

The mobile transport cart of this invention preferably has the following major operating components.

Compact Frame: The frame is heavy duty steel and is very low profile, it fits under most aircraft wings. The frame and frame components are manufactured of high strength materials to ensure the cylinders are secure during operation and transportation. The compact frame allows for a tight turning radius.

Rotating Cylinder Loader/Un-Loader: The precision cylinder loader system allows for stable and efficient rotational motion guidance under variable weights, speeds and high load conditions keeping the cylinders in the correct location. The rotating cylinder loaders are controlled by precision engineered struts that control the rotating of the cylinders from the vertical and horizontal positions. The rotating loader arms are designed to accommodate any cylinders weighing less than 200 pounds and 60″ tall up to 9.75″ diameter. The loaders are manufactured of high strength materials to ensure the cylinders are secure. The rotational loader is locked into place by a spring loaded plunger that locks the loader into in either horizontal or vertical position. The rotational loading of this cart makes unloading, transporting, servicing and moving the cylinders a one person operation.

Control Panel and Booster: The control panel operates off a standard nitrogen or oxygen source and 400 psi pressure and 80SCFM flow. The control panel allow operator to view cylinder pressures, regulate high pressure output (25-4000 psi) and regulate low pressure output (0-500 psi).

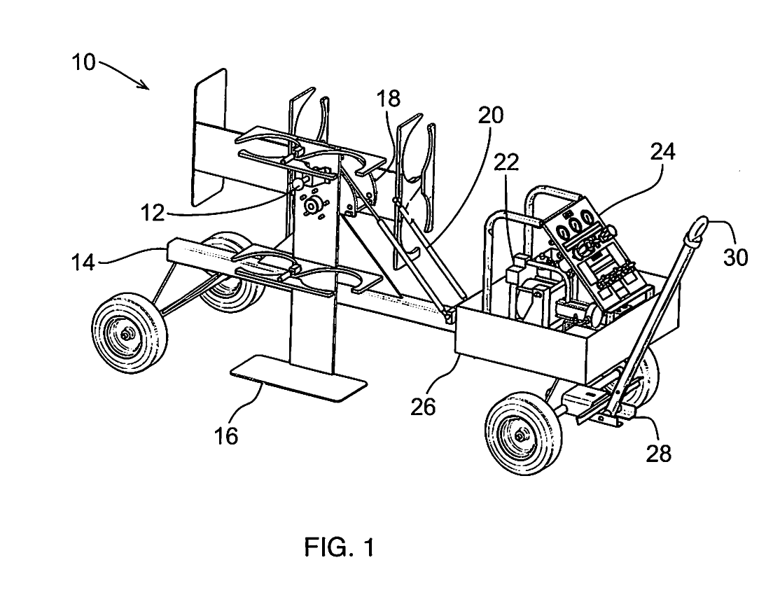

FIG. 1 is a general view of the mobile transport cart of this invention. FIG. 1 identifies the major components of the cart.

FIG. 1 shows four cylinder cart 10. Cart 10 comprises cylinder loader locking pin 12. Cart 10 also includes compact frame 14, rotating cylinder loader 16, and loader locking mechanism 18. Cart 10 further comprises precision engineered strut 20, booster 22, control panel 24, hose compartment 26, front truck assembly 28 and towbar 30.

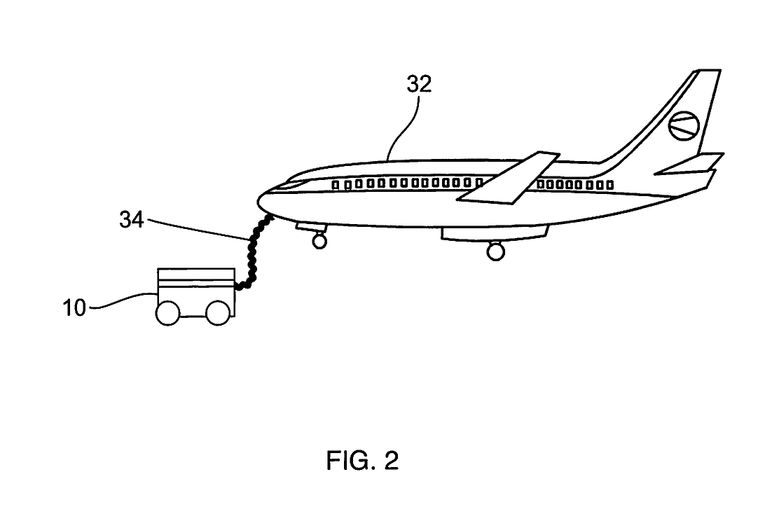

FIG. 2 is a general view showing a typical aircraft. FIG. 2 shows the mobile transport cart of this invention and a typical aircraft. FIG. 2 shows cart 10, aircraft 32 with hose 34 connecting the two.

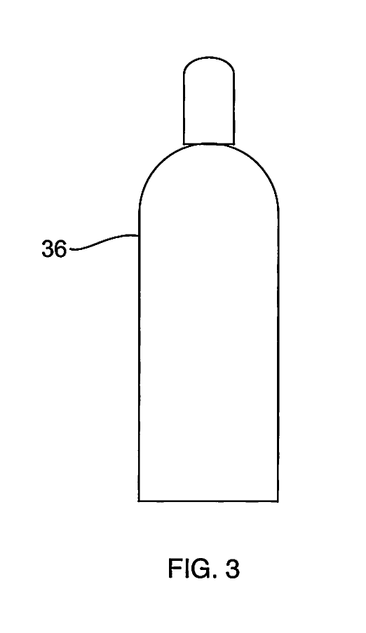

FIG. 3 is a general view showing a typical gas (nitrogen or oxygen) cylinder (bottle) 36.

### Example I

The cart of this invention has the following features.

### SPECIFICATIONS/FEATURES

### Dimensions

Height: 43-½ in (111 cm)

Length: 92 in (234 cm)

Width: 35-¾ in (91 cm)

Weight: 500 lbs (163 kg) without cylinders

### Cart

CE

Easy loading

Use with all standard nine inch (9 in/22.9 cm) diameter

Nitrogen bottles; CGA 580 connection with check valves, 3000 psi max

Bottles fully captured

Pneumatic tires

Parking brake

Hose compartment storage tray

Instrument Panel

### Booster

Output hose: 25 ft (7.6 m) long with #4, 37° JIC (female flared swivel fitting) at aircraft hook-up end

Minimum supply bottle pressure: 250 psig (17 bar)

Nitrogen input to booster pump: 80 SCFM at 150 psig (10.3 bar) maximum

Booster high pressure air pilot: 4000 psig (276 bar)

Booster high pressure relief: 4400 psig (303.4 bar)

### Low Pressure Regulator

0-500 psi (34.5 bar) rated output

15 foot (4.6 m) service hose

### Temperature Range

0° to 200° (17.7° to 93.3° C.)

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. An apparatus for servicing an aircraft, comprising a mobile, cylinder transport cart wherein the transport cart is configured to minimize the handling of compressed gas cylinders in loading and unloading, transporting and servicing process for an aircraft and wherein the cart is configured to handle a multiplicity of the compressed gas cylinders.

2. An apparatus according to claim 1, wherein the transport cart is a four cylinder transport cart.

3. An apparatus according to claim 1, wherein the compressed gas cylinders are nitrogen or oxygen cylinders.

4. An apparatus according to claim 1 further comprising a booster system configured to provide high and low pressure regulated pressure output.

5. An apparatus according to claim 1 wherein the cart has a very narrow footprint and a tight turning radius allowing the cart to maneuver easily.

6. An apparatus according to claim 1 further comprising a forward tray that houses the oxygen and nitrogen cylinders including hoses, regulators, control panel and operating instructions.

7. An apparatus according to claim 1 further comprising:
a compact frame;
a rotating cylinder loader/unloader;
a cylinder loader locking pin;
a loader locking mechanism; and
precision engineered struts.

8. An apparatus according to claim 1 further comprising a control unit coupled to the control panel for enabling and controlling operation of the transport cart.

9. An apparatus according to claim 1 further comprising a power unit to deliver power to the transport cart.

10. An apparatus according to claim 7 wherein the loader locking mechanism is a cylinder locking clamp.

11. An apparatus according to claim 7 wherein the loader locking mechanism is a spring loaded plunger that locks rotating cylinder loader into in either a horizontal or a vertical position.

12. An apparatus according to claim 7 wherein the precision engineered struts are configured to control the rotating of the cylinders from the vertical and horizontal positions.

13. An apparatus according to claim 8 wherein the control unit and control panel are configured to follow a correct loading sequence of loading the forward cylinder (the cylinder closest to the tray or towbar) then load the second cylinder.

14. An apparatus according to claim 8 wherein the control unit and control panel are configured to follow an alternate loading procedure of loading one cylinder in a forward position on each side to keep the cart balanced and with the lowest center of gravity if only two cylinders are loaded onto the cart.

15. An apparatus according to claim 8 wherein the control unit and control panel are configured to follow an alternate loading procedure of loading one side with two cylinders and loading the second side with one cylinder in the forward position as if only three cylinders are loaded onto the cart.
